(19) United States
(12) Patent Application Publication
(10) Pub. No.: US 2006/0209722 A1
(43) Pub. Date: Sep. 21, 2006

(54) Data transferring system and electronic apparatus

(76) Inventors: Koji Takeo, Miyagi (JP); Noriyuki Terao, Miyagi (JP); Junichi Ikeda, Miyagi (JP); Koji Oshikiri, Miyagi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/327,426

(22) Filed: Jan. 9, 2006

(30) Foreign Application Priority Data
Jan. 17, 2005 (JP) 2005-008866

(51) Int. Cl. H04L 12/28

(52) U.S. Cl. 370/254

(57) ABSTRACT

A data transferring system, in which processes to match settings between devices mutually communicating are simplified, software for the processes is also simplified, and the amount of data to be processed is reduced, is disclosed. In a data transferring system of the PCI Express standard, when settings between facing ports of a switch and an end point are changed, a setting change is transmitted to the port of the end point being one of the facing ports by a configuration request. The port of the end point transmits the setting change to the port of the switch by a message request and the port of the switch executes the setting change. The port of the switch sends a completion message signifying the setting change completion to the port of the end point by a message request. The port of the end point executes the setting change.

### BACKGROUND OF THE INVENTION

1. Field of the Invention

The present invention generally relates to a data transferring system that transfers data and an electronic apparatus that provides the data transferring system.

2. Description of the Related Art

As a high speed serial interface, an interface called PCI Express (peripheral component interconnect express, registered trademark) being a successor of PCI is proposed (for example, refer to Non-Patent Document 1).

In an auto-negotiation of Ethernet (registered trademark) using a UTP (unshielded twist pair cable), in each link executing mutual communications, a transfer rate and a communication mode (full duplex or half duplex) are independently negotiated and mutual matching is established.

[Non-Patent Document 1 ] Outline of the PCI Express Standard, Interface July 2003, written by Takashi Satomi

In the PCI Express standard, when the matching of settings such as a maximum payload size in a link and virtual channels between mutual ports which execute communications is not accomplished, some parameters do not normally function.

In devices (switches and end points) which execute communications based on the PCI Express standard, a function of matching the settings is not stipulated. Therefore, a CPU (CPU of a root complex) which controls the devices must match the settings based on software.

Further, conventionally, the CPU must send an instruction to match the settings to each of facing ports that execute communications.

In addition, each of the devices in the PCI Express standard is uniquely recognized by its bus number and its device number. However, the bus number and the device number of a destination device are not evident for a specific source device, that is, for a specific end point, the bus number and the device number of a port of a destination switch are not evident. Therefore, in order to recognize the bus number and the device number of the destination device, the CPU must execute complicated processes that search a tree structure composed of the devices of the PCI Express standard.

Consequently, in the CPU, the processes to match the settings between the devices that execute the mutual communications become complex.

Therefore, there is a problem in that the software becomes complex and must process a large amount of data.

### SUMMARY OF THE INVENTION

In a preferred embodiment of the present invention, there is provided a data transferring system and an electronic apparatus providing the data transferring system in which processes that match settings between devices that execute mutual communications are simplified, software is also simplified, and the amount of data to be processed is reduced.

Features and advantages of the present invention are set forth in the description that follows, and in part will become apparent from the description and the accompanying drawings, or may be learned by practice of the invention according to the teachings provided in the description. Objects as well as other features and advantages of the present invention will be realized and attained by a data transferring system and an electronic apparatus providing the data transferring system particularly pointed out in the specification in such full, clear, concise, and exact terms as to enable a person having ordinary skill in the art to practice the invention.

To achieve these and other advantages in accordance with the purpose of the present invention, according to one aspect of the present invention, there is provided a data transferring system, in which a data transferring route has a tree structure and a connection between nodes on the tree structure is point to point and communications between facing nodes are executed by matching settings between facing ports of the facing nodes. The data transferring system includes a first notifying unit that notifies one of the facing ports of a setting change when settings between the facing ports are to be changed, a second notifying unit that is a port having received the notification of the setting change and notifies the other port of the setting change, a first setting change unit that is the other port having received the notification of the setting change and executes the setting change, and a second setting change unit that is the port having received execution of the setting change from the other port and executes the setting change.

### EFFECT OF THE INVENTION

According to an embodiment of the present invention, since a setting change can be executed in both facing ports by notifying only one of the facing ports of the setting change by the first notifying unit, processes for matching settings between the facing ports that execute mutual communications are simplified, software is also simplified, and the amount of data to be processed can be reduced.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram showing a configuration of an existing PCI system;

FIG. 2 is a block diagram showing a configuration of a PCI Express system;

FIG. 3 is a block diagram showing a PCI Express platform in a desktop/a mobile computer;

FIG. 4 is a schematic diagram showing a configuration of physical layers in a case of N=×4 (N is the number of lanes of which a link is composed);

FIG. 5 is a schematic diagram showing a lane connection example between devices;

FIG. 6 is a block diagram showing an example of a logical structure of a switch;

FIG. 7A is a block diagram showing existing PCI architecture;

FIG. 7B is a block diagram showing PCI Express architecture;

FIG. 8 is a block diagram showing a layered structure of the PCI Express architecture;

FIG. 9 is a diagram showing a format example of a TLP (transaction layer packet);

FIG. 10 is a diagram showing a configuration memory space of PCI Express;

FIG. 11 is a schematic diagram explaining a concept of virtual channels;

FIG. 12 is a diagram explaining a format example of a DLLP (data link layer packet);

FIG. 13 is a schematic diagram showing a byte striping example in a ×4 link;

FIG. 14 is a diagram explaining a definition of link states L0, L0s, L1, and L2;

FIG. 15 is a timing chart showing a control example of power source management in the link states;

FIG. 16 is a block diagram showing a configuration of a digital copying machine according to an embodiment of the present invention;

FIG. 17 is a block diagram showing a data transferring system based on the PCI Express standard which is used by the digital copying machine shown in FIG. 16;

FIG. 18 is a communications sequence chart of the data transferring system shown in FIG. 17;

FIG. 19 is a flowchart showing processes that are executed by the data transferring system shown in FIG. 17;

FIG. 20 is a flowchart showing a subroutine which is executed by an end point in step 2 shown in FIG. 19;

FIG. 21 is a flowchart showing processes which are executed by ports of the end point receiving a configuration request and a switch receiving a configuration message;

FIG. 22 is a block diagram showing a conventional data transferring system based on the PCI Express standard; and

FIG. 23 is a communication sequence chart of the conventional data transferring system shown in FIG. 22.

### DESCRIPTION OF THE PREFERRED EMBODIMENT

[Best Mode of Carrying Out the Invention]

A best mode of carrying out the present invention is described with reference to the accompanying drawings.

In the following, first, details of the PCI Express standard are explained in “Outline of the PCI Express Standard” to “Details of Architecture of PCI Express”, and subsequently, “Digital Copying Machine” according to an embodiment of the present invention is explained.

[Outline of the PCI Express Standard]

The embodiment of the present invention utilizes PCI Express being one of the high speed serial buses, and as a premise of the embodiment of the present invention, the outline of the PCI Express Standard is explained by using an extract of Non-Patent Document 1. In this, the high speed serial bus signifies an interface that can transmit data in a high speed (approximately over 100 Mbps) by serial transmission with the use of one transmission line.

PCI Express is a bus standardized as a standard extended bus capable of being used in all computers as a successor to PCI, and has features, such as low voltage differential signal transmission, independent communication channels for reception and transmission in point to point, packetized split transaction, and high scalability depending on difference of link structures.

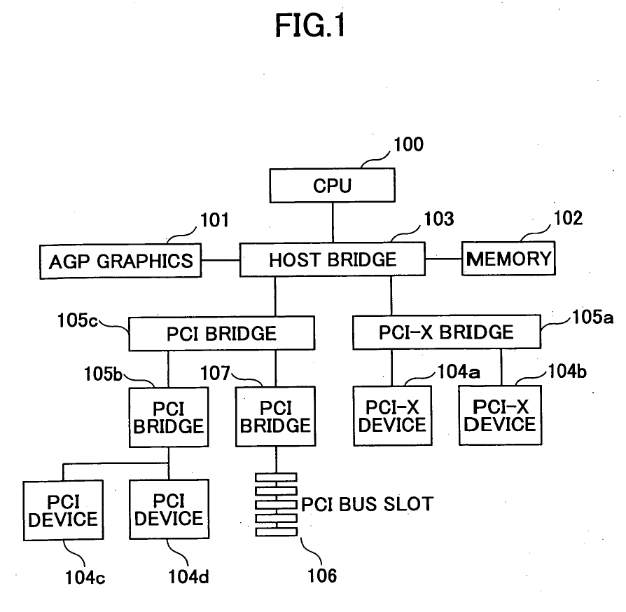

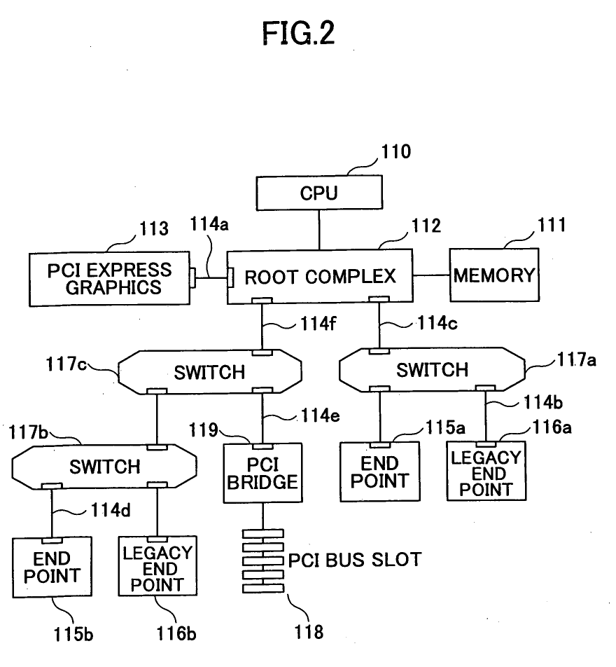

FIG. 1 is a block diagram showing a configuration of an existing PCI system. FIG. 2 is a block diagram showing a configuration of a PCI Express system. In the existing PCI system shown in FIG. 1, a tree structure is formed. In the tree structure, PCI-X devices 104a and 104b (of the upward compatibility standard of PCI) are connected to a host bridge 103, to which a CPU 100, an AGP graphics 101, and a memory 102 are connected, via a PCI-X bridge 105a. Further, a PCI bridge 105b to which PCI devices 104c and 104d are connected and a PCI bridge 107 to which PCI bus slots 106 are connected are connected to the host bridge 103 via a PCI bridge 105c.

In the PCI Express system shown in FIG. 2, a tree structure is also formed. In the tree structure, a PCI Express graphics (port) 113 is connected to a root complex 112, to which a CPU 110 and a memory 111 are connected, by a PCI Express link 114a; a switch 117a, to which an end point 115a and a legacy end point 116a are connected by PCI Express links 114b, is connected to the root complex 112 by a PCI Express link 114c; a switch 117b, to which an end point 115b and a legacy end point 116b are connected by PCI Express links 114d, and a PCI bridge 119, to which PCI bus slots 118 are connected, are connected to a switch 117c by PCI Express links 114e; and the switch 117c is connected to the root complex 112 by a PCI Express link 114f.

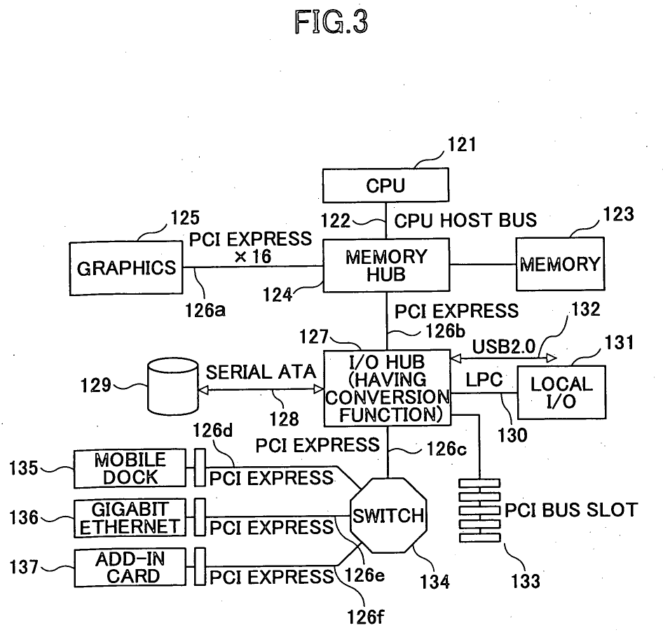

FIG. 3 is a block diagram showing a PCI Express platform in a desktop/a mobile computer. The PCI Express platform shown in FIG. 3 is an example which is assumed to be actually used. In FIG. 3, A CPU 121 is connected to a memory hub 124 (corresponding to a root complex), to which a memory 123 is connected, by a CPU host bus 122. A graphics (port) 125 is connected to the memory hub 124 by a PCI Express link 126a of ×16. An I/O hub 127 having a conversion function is connected to the memory hub 124 by a PCI Express link 126a. Storage 129 is connected to the I/O hub 127 by, for example, a serial ATA (serial AT attachment) 128. A local I/O 131 is connected to the I/O hub 127 by an LPC (low pin count) connector 130, and a USB 2.0 132 and PCI bus slots 133 are connected to the I/O hub 127. Further, a switch 134 is connected to the I/O hub 127 by a PCI Express link 126c, a mobile dock 135 is connected to the switch 134 by a PCI Express link 126d, a gigabit Ethernet LAN 136 is connected to the switch 134 by a PCI Express link 126e, and an add-in card 137 is connected to the switch 134 by a PCI Express link 126f.

That is, in the PCI Express system, conventional buses, such as a PCI bus, a PCI-X bus, and an AGP bus are replaced by the PCI Express buses, and bridges (not shown) are used to connect the existing PCI/PCI-X devices. The connections between chip sets are executed by PCI Express connections, and existing buses, such as an IEEE 1394 (not shown), the Serial ATA 128, and the USB 2.0 132 are connected to the PCI Express buses by the I/O hub 127.

[Configuration Elements of PCI Express]

A. Port/Lane/Link

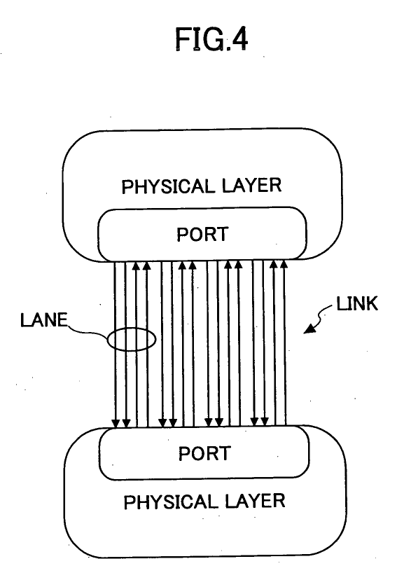

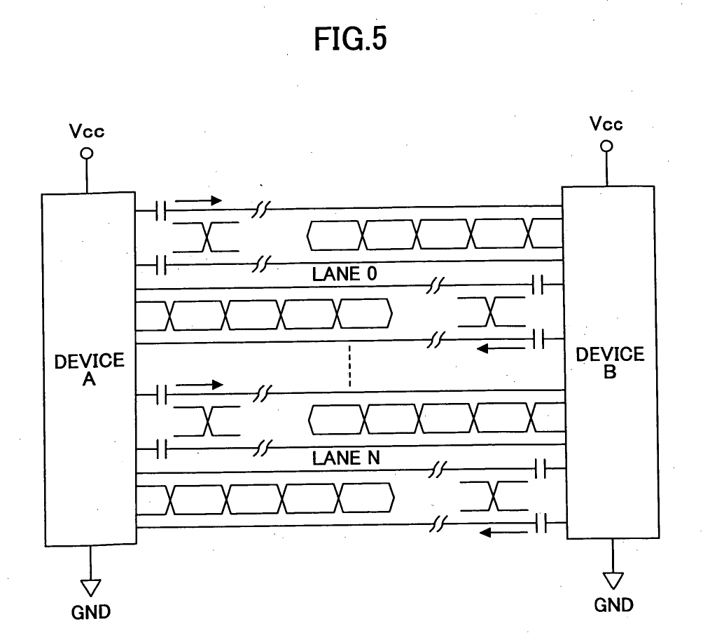

FIG. 4 is a schematic diagram showing a configuration of physical layers in a case of N=×4 (N is described below). Ports are physically in the same semiconductor device and are a set of transmitters/receivers forming links and signify interfaces which connect components logically one to one (point to point). The transfer rate is, for example, 2.5 Gbps in one direction (for the future, 5 Gbps and 10 Gbps are assumed). A lane is a set of two pairs of differential signals of, for example, 0.8 V, and is composed of a pair of transmission side signals (2 pieces) and a pair of reception side signals (2 pieces). A link is a group of lanes connecting the two ports and a dual simplex communication bus between components (devices). A “×N link” is composed of N lanes and N=1, 2, 4, 8, 16, and 32 are defined in the current standard. In FIG. 4, a case of ×4 link is shown. FIG. 5 is a schematic diagram showing a lane connection example between devices. As shown in FIG. 5, when the lane width N connecting devices A and B is variable, a scalable band width can be obtained.

B. Root Complex

The root complex 112 (refer to FIG. 2) is located in the upper most position of the I/O structure and connects a CPU and a memory subsystem to I/Os. In many cases, as shown in FIG. 3, the root complex is described as a memory hub in a block diagram. The root complex 112 (the memory hub 124) has one or more PCI Express ports (root ports), and each PCI Express port forms an independent I/O layer domain. In FIG. 2, rectangles in the root complex 112 are the PCI Express ports. The I/O layer domain may be a simple end point (for example, a case of the side of the end point 115a in FIG. 2) or may be formed by many switches and end points (for example, a case of the side of the end point 115b and the switches 117b and 117c).

C. End Point

The end point (115, 116) is a device which has a configuration space header of type 00h and is specifically a device other than a bridge. There are a legacy end point and a PCI Express end point (simply an end point) in the end points. The PCI Express end point is a BAR (base address register) and basically does not request an I/O port resource or an I/O request due to this. Further, the PCI Express end point does not support a lock request. The above are big differences between the legacy end point and the PCI Express end point.

D. Switch

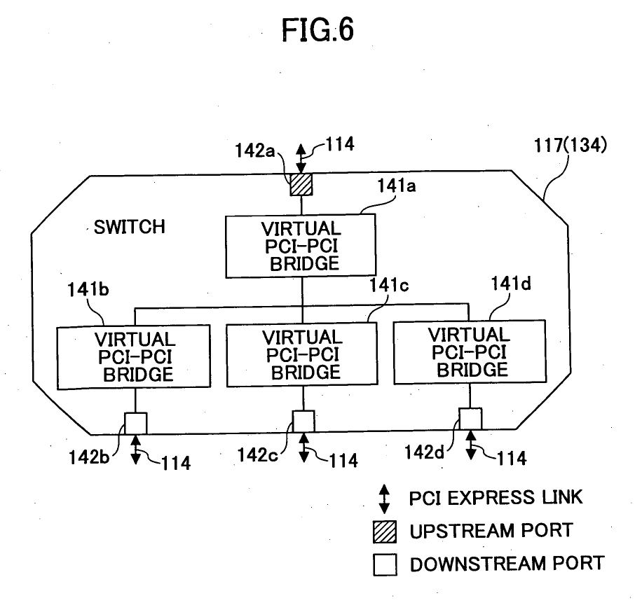

The switch (117, 134) connects two or more ports and executes packet routing among the ports. FIG. 6 is a block diagram showing an example of a logical structure of the switch. As shown in FIG. 6, the switch is recognized as a group of virtual PCI-PCI bridges 141 (141a to 141d) from configuration software. In FIG. 6, arrows show the PCI Express links 114, 126 (114b to 114f, 126c to 126f) and the reference numbers 142a to 142d show ports. The port 142a is an upstream port near the root complex and the ports 142b to 142d are downstream ports far from the root complex.

E. PCI Express Link 114e to PCI Bridge 119

The PCI Express link 114e to the PCI bridge 119 gives a connection from PCI Express to PCI/PCI-X. With this, the existing PCI/PCI-X devices can be used on the PCI Express system.

[Layered Architecture]

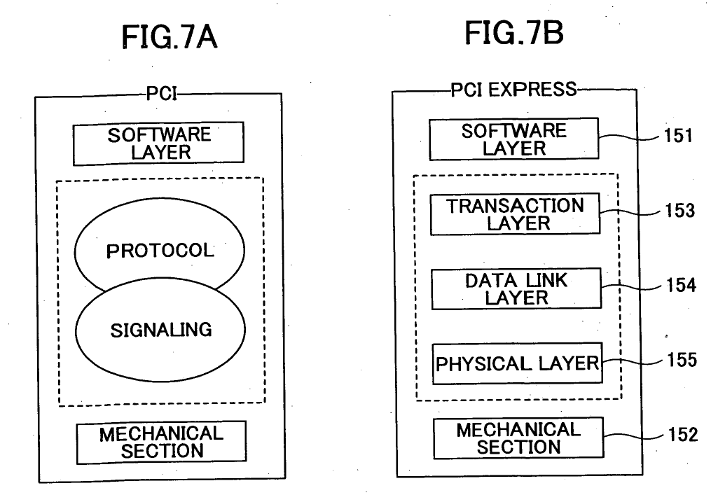

FIG. 7A is a block diagram showing existing PCI architecture. FIG. 7B is a block diagram showing PCI Express architecture. As shown in FIG. 7A, the existing PCI architecture has a structure in which the protocol closely relates to the signaling and does not have the concept of layers. However, as shown in FIG. 7B, the PCI Express architecture has a layered structure and the specification of each layer is defined, similar to the general communication protocol and InfiniBand (registered trademark). That is, the PCI Express architecture has a structure in which a transaction layer 153, a data link layer 154, and a physical layer 155 are disposed between a software layer 151 located in the uppermost position and a mechanical section 152 located in the lowest position. With this structure, the module property of each layer is secured, scalability can be given, and each module can be reused. For example, when a new signal coding system is used or a new transmission medium is used, the data link layer 154 and the transaction layer 153 can be used as they are and only the physical layer 155 is changed.

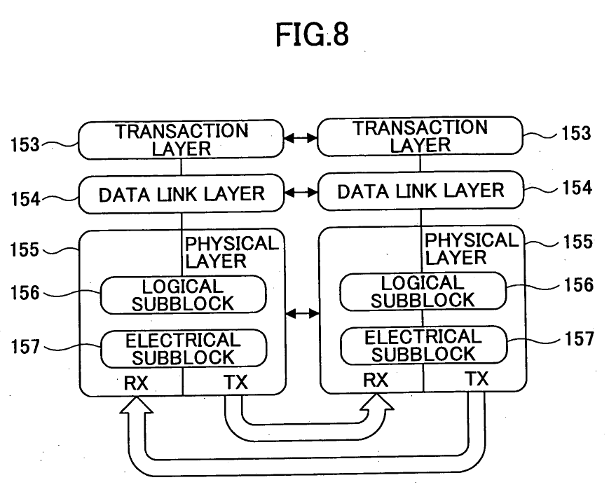

The center of the PCI Express architecture is the transaction layer 153, the data link layer 154, and the physical layer 155. Referring to FIG. 8, each layer is explained. FIG. 8 is a block diagram showing the layered structure of the PCI Express architecture.

A. Transaction Layer 153

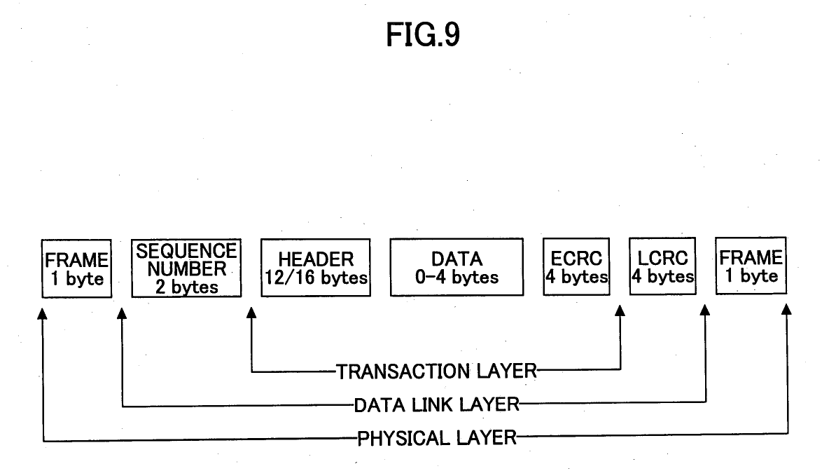

The transaction layer 153 is located in the uppermost position and has a function that assembles and separates TLPs (transaction layer packets). The TLP is used for transference of transactions, such as read/write, and various events. In addition, the transaction layer 153 executes flow control using a credit for the TLP. FIG. 9 is a diagram showing a format example of the TLP. In FIG. 9, an outline of the TLP is shown in relation to the layers 153 to 155. The details of the TLP are explained below.

B. Data Link Layer 154

The main role of the data link layer 154 is to ensure data completeness of the TLP by error detection/correction (retransmission) and execute link management. Exchanging packets for the link management and the flow control are executed between the data link layers 154. These packets are called DLLPs (data link layer packets) so as to distinguish them from the TLPs.

C. Physical Layer 155

The physical layer 155 includes circuits necessary for interface operations, such as a driver, an input buffer, a parallel to serial/serial to parallel converter, a PLL circuit, and an impedance matching circuit. In addition, the physical layer 155 has a function to initialize/maintain the interface as a logic function. Further, the physical layer 155 has a role which makes the data link layer 154/the transaction layer 153 independent from signal technology being used in the actual link.

In this, a technology called an embedded clock is used for a hardware structure of PCI Express, where timing of the clock is embedded in data signals without using clock signals, and a clock is extracted based on a cross point of data signals at the reception side.

[Configuration Space]

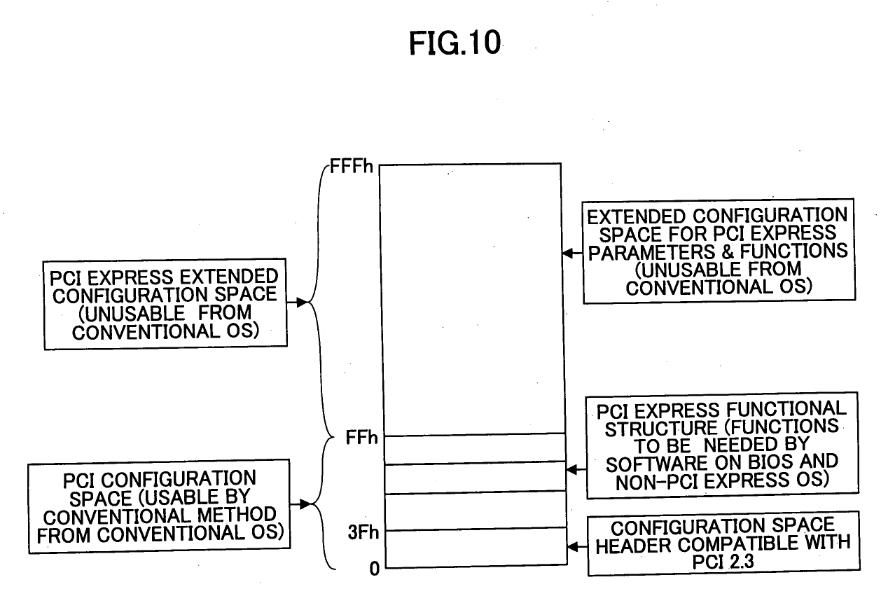

FIG. 10 is a diagram showing a configuration memory space of PCI Express. PCI Express has a configuration space like the conventional PCI, the configuration space of the conventional PCI is 256 bytes; however, as shown in FIG. 10, the configuration space of the PCI Express is extended to 4096 bytes. With this configuration space, enough space is secured for a device such as a host bridge which will need many device intrinsic register sets in the future. In PCI Express, access to the configuration space is executed by access (configuration read/write) to a flat memory space, and bus/device/function/register numbers are mapped in a memory register.

From a BIOS or a conventional OS, a method using an I/O port can access the first 256 bytes in the configuration space, as a PCI configuration space. A function which converts conventional access into PCI Express access is installed in the host bridge. The range from 00h to 3Fh is a configuration header compatible with PCI 2.3. With this, a conventional OS and software can be used as they are except for functions extended by PCI Express. That is, the software layer 151 in PCI Express succeeds to load/store architecture (a processor directly accesses an I/O register) which maintains the compatibility with the existing PCI. However, when functions extended by PCI Express, such as synchronized transfer, RAS (reliability, availability, and serviceability) functions, are used, it is required to access the PCI Express extended space of 4K bytes.

In this, as PCI Express, various form factors are assumed; however, as specific examples, there are an add-in card, a plug-in card (Express card), a mini PCI Express card, and so on.

[Details of PCI Express Architecture]

The transaction layer 153, the data link layer 154, and the physical layer 155 being the center of the PCI Express architecture are explained in detail.

A. Transaction Layer 153

As described above, the main role of the transaction layer 153 is to assemble and separate TLPs between the upper software layer 151 and the lower data link layer 154.

Aa. Address Space and Transaction Type

In PCI Express, in addition to a memory space (for data transfer to another memory space), an I/O space (for data transfer to another I/O space), a configuration space (for setting up and configuration of a device), which are supported by the conventional PCI, a message space is added, that is, four address spaces are defined. The message space is used for transmission (exchange) of messages, such as event notification in band and a general message between devices of PCI Express, and an interrupt request and acknowledgement is transferred by using the message as a virtual wire. Further, a transaction type is defined in each of the address spaces. The memory space, the I/O space, and the configuration space are read/write types, and the message space is a basic type (including a vendor definition).

Ab. TLP (Transaction Layer Packet)

PCI Express executes communications in a packet unit. In the format of the TLP shown in FIG. 9, the length of the header is 3DW (DW signifies double words and 3DW is 12 bytes) or 4DW (16 bytes). In the header, information, such as the format of the TLP (the length of the header and the existence of a payload), the transaction type, a traffic class (TL), an attribute, and a payload length, is included. The maximum payload length in a packet is 1024 DW (4096 bytes).

ECRC is used to ensure the completeness of data in end to end, and is 32 bits CRC in a part of the TLP. When in a switch, if an error occurs in the TLP, the error cannot be detected by LCRC (link CRC) because the LCRC is recalculated in the TLP where the error occurs; therefore, the ECRC is installed.

In requests, there is a request that needs a complete packet and a request that does not need the complete packet.

Ac. TC (Traffic Class) and VC (Virtual Channel)

Upper software can give priority to traffic by using the TC. For example, transferring image data can be given priority in transferring the image data and network data. The TC has eight classes TC0 to TC7.

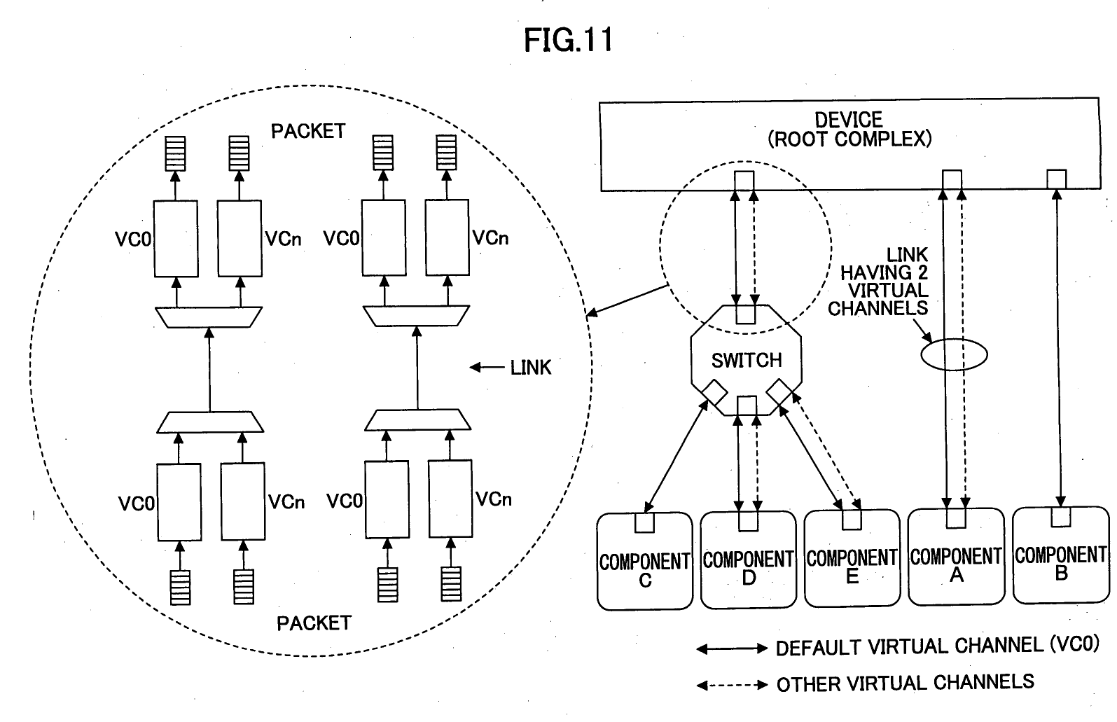

Each of VCs is an independent virtual communication bus and has a resource (buffer and queue). The independent virtual communication buses are mechanisms which use plural independent data flow buffers using the same link in common. FIG. 11 is a schematic diagram explaining the concept of the VCs. As shown in FIG. 11, the VCs execute independent flow control. Even when a buffer of a VC is full, data can be transferred by another VC. That is, one link can be effectively used by dividing the physical one link into plural VCs. For example, as shown in FIG. 11, in a case where a link from a root complex (device) is divided into plural devices (components) via a switch, priority of traffic to each device (component) can be controlled. VC0 is indispensable and other VCs (VC1 to VC7) are installed corresponding to a tradeoff of cost and performance. In FIG. 11, a continuous arrow line shows a default VC (VC0) and a broken arrow line shows other VCs (VC1 to VC7).

In the transaction layer 153, the TC is mapped on the VC. When the number of VCs is small, one or more TCs can be mapped on one VC. In a simple case, it is considered that each TC is mapped on each VC one to one and all TCs are mapped on the VC0. The mapping of TC0 on VC0 is indispensable (fixed), and the other mapping is controlled by the upper software. The software can control the priority by utilizing the TCs.

Ad. Flow Control

FC (flow control) is executed to establish transfer order by avoiding an overflow in a reception buffer. The flow control is executed point to point between links, not end to end. Consequently, a packet reaching a final destination (completer) cannot be acknowledged by the flow control.

The flow control in PCI Express is executed by a credit base. That is, the following mechanism is used. The empty state of a reception side buffer is confirmed before starting the data transmission and overflow and underflow in the buffer are avoided. In other words, the reception side notifies a transmission side of buffer capacity (credit value) at the time of initializing the link, and the transmission side compares the credit value with the length of packets to be transmitted. When the credit value has remaining capacity, the packets are transmitted. There are six types of credits.

Exchanging the information of the flow control is executed by using DLLP (data link layer packet) of the data link layer 154. The flow control is applied only to the TLP and is not applied to the DLLP. Therefore, the DLLP can always be transmitted/received.

B. Data Link Layer 154

As described above, the main role of the data link layer 154 is to provide an exchanging function of the TLPs between two components on a link with high reliability.

Ba. Handling of TLPs

The data link layer 154 adds a sequence number of 2 bytes to its head and an LCRC (link CRC) of 4 Bytes to its tail of the TLP received from the transaction layer 153, and gives it to the physical layer 155 (refer to FIG. 9). The TLPs are stored in a retry buffer and retransmitted to a destination until an acknowledgment is received from the destination. When transmission failure of the TLPs continues, the data link layer 154 decides that the link is abnormal and requires the physical layer 155 to execute retraining of the link. When the training of the link fails, the state of the data link layer 154 is shifted to be inactive.

The sequence number and the LCRC of the TLP received from the physical layer 155 of the transmission side are inspected, and when they are normal, the TLP is sent to the transaction layer 153; when they are abnormal, the reception side requires the transmission side to retransmit the TLP.

Bb. DLLP (data link layer packet)

A packet generated by the data link layer 154 is called a DLLP, and the DLLP is exchanged between the data link layers 154. The DLLP has the following types:

1. Ack/Nak (reception confirmation and retry (retransmission) of TLP)

2. InitFC1/InitFC2/UpdateFC (initialization and update of Flow Control)

3. Power Source Management

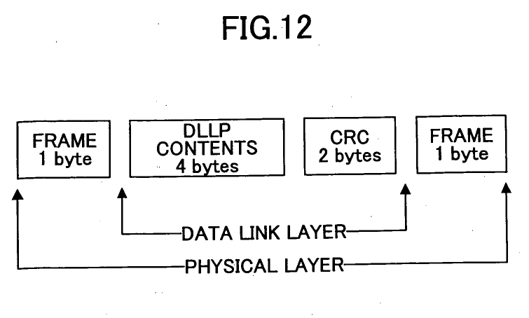

FIG. 12 is a diagram explaining a format example of the DLLP. As shown in FIG. 12, the length of the DLLP is 6 bytes and is composed of DLLP contents of 4 bytes (a DLLP type of 1 byte for showing a type and intrinsic information of the type of 3 bytes) and a CRC of 2 bytes.

C. Logical Subblock 156 in Physical Layer 155

The main role of the logical subblock 156 in the physical layer 155 is to convert a packet received from the data link layer 154 into a packet which an electric subblock 157 can transmit (refer to FIG. 8). Further, the logical subblock 156 has a function of controlling/managing the physical layer 155.

Ca. Data Encoding and Parallel to Serial Conversion

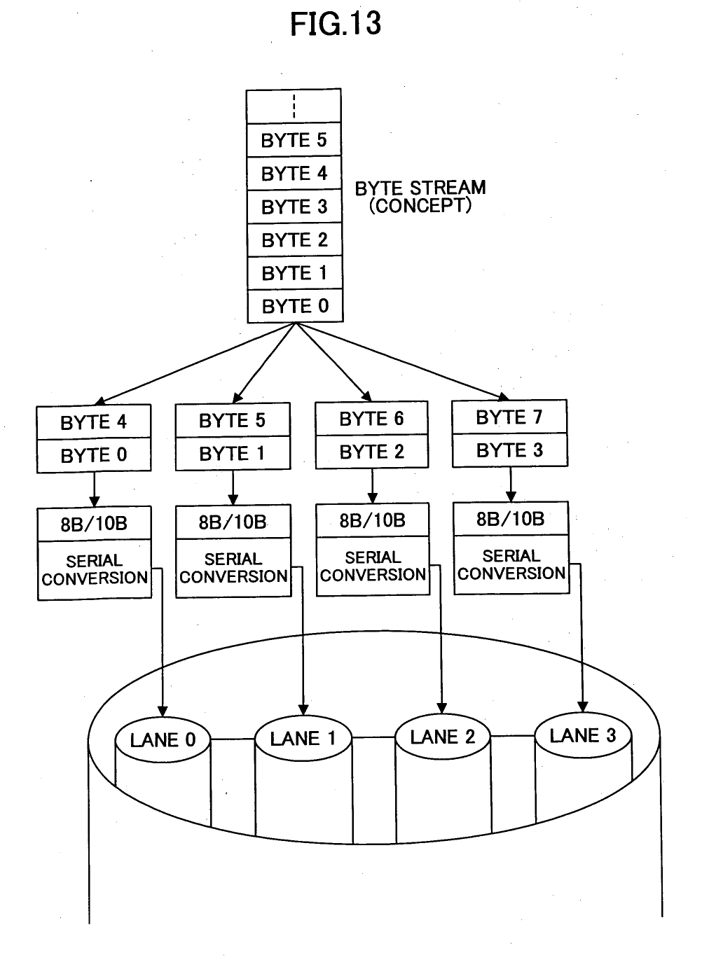

In PCI Express, in order not to remain in a sequence of “0”s or “1”s, that is, in order not to continue without a cross point for a long time, 8B/10B conversion is used for data encoding. FIG. 13 is a schematic diagram showing a byte striping example in a ×4 link. As shown in FIG. 13, serial conversion is applied to the converted data and data from an LSB are transmitted in order on the lane. When plural lanes exist (a case of the ×4 link is shown in FIG. 13), data are allocated to each lane in a byte unit before encoding. In this case, at first sight, this looks like a parallel bus; however, transferring is independently executed in each lane, consequently, skewing being a problem in the parallel bus can be greatly reduced.

Cb. Power Source Management and Link State

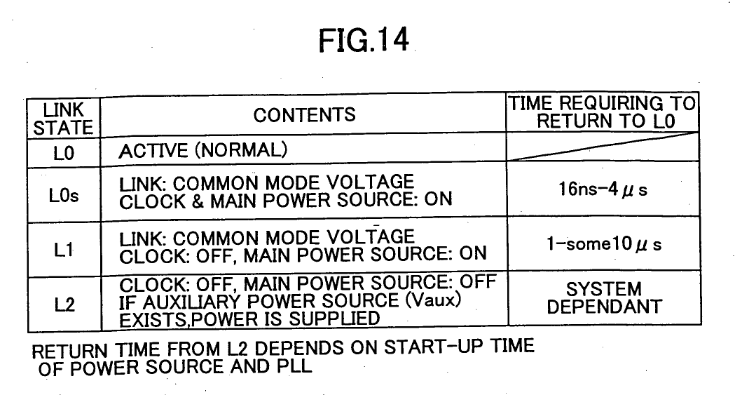

FIG. 14 is a diagram explaining the definition of link states L0, L0s, L1, and L2. As shown in FIG. 14, in order to make power consumption of links low, the link states L0, L0s, L1, and L2 are defined.

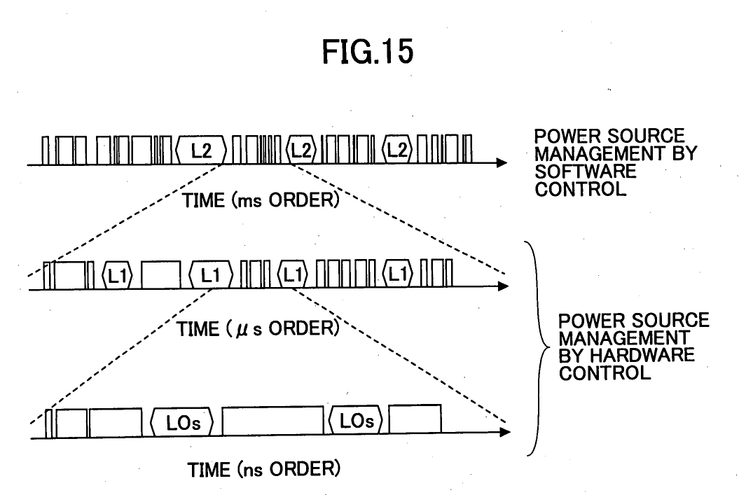

The link state L0 is a normal mode and the power consumption is gradually lowered when the link state is changed from the L0s to L2; however, time requiring to return to the link state L0 becomes longer. FIG. 15 is a timing chart showing a control example of power source management in the link states. As shown in FIG. 15, when the power source management by a hardware control is executed in addition to power source management by software control, the power consumption can be lowered to be as small as possible.

D. Electrical Subblock 157 in Physical Layer 155

The main role of the electrical subblock 157 in the physical layer 155 is to transmit data serialized by the logical subblock 156 to a lane, to receive data from a lane, and to send the received data to the logical subblock 156 (refer to FIG. 8).

Da. AC Coupling

A capacitor for AC coupling is mounted in the transmission side of the link. With this, it is not necessary that a DC common mode voltage be the same in the transmission side and the reception side. Therefore, in the transmission side and the reception side, mutually different designing, a different specification of a semiconductor device, and a different power voltage can be used.

Db. De-Emphasis

As described above, in PCI Express, by the 8B/10B encoding, data are processed so that a sequence of “0”s or “1”s does not persist. However, there is a case where a sequence of “0”s or “1”s persists (at maximum 5). In this case, it is stipulated that the transmission side execute de-emphasis transfer. When the same polarity bits continue, it is necessary that a noise margin of a signal received at the reception side be obtained by lowering the differential voltage level (amplitude) by 3.5±0.5 dB from the second bit. This is called the de-emphasis. By the frequency dependent attenuation in the transmission line, since changing bits have high frequency components, the waveform of the reception side becomes small by the attenuation; however, in unchanging bits, the high frequency components are few and the waveform of the reception side becomes relatively large. Therefore, the de-emphasis is applied to make the waveform at the reception side constant.

[Digital Copying Machine]

Next, a digital copying machine according to an embodiment of the present invention is explained.

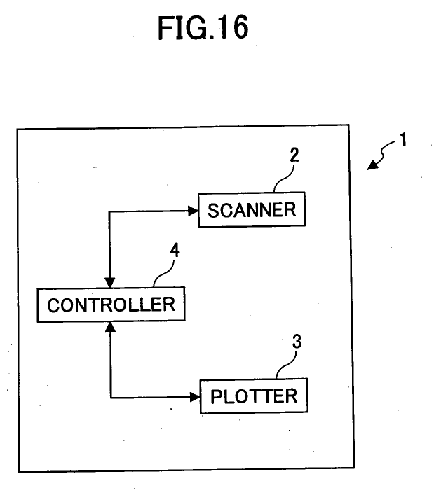

FIG. 16 is a block diagram showing a configuration of the digital copying machine according to the embodiment of the present invention. As shown in FIG. 16, a digital copying machine 1 according to the embodiment of the present invention includes a scanner 2 that reads image data of a manuscript, a plotter 3 that forms an image on a medium such as a paper based on the image data read by the scanner 1, and a controller 4 that totally controls the digital copying machine 1. As printing systems of the image data by the plotter 3, there are various systems, such as, an electro-photographic system, an ink-jet system, a sublimation thermal transcription system, a sliver film photographic system, a direct thermo sensitive recording system, and a melting thermal transcription system, and any one of them can be used.

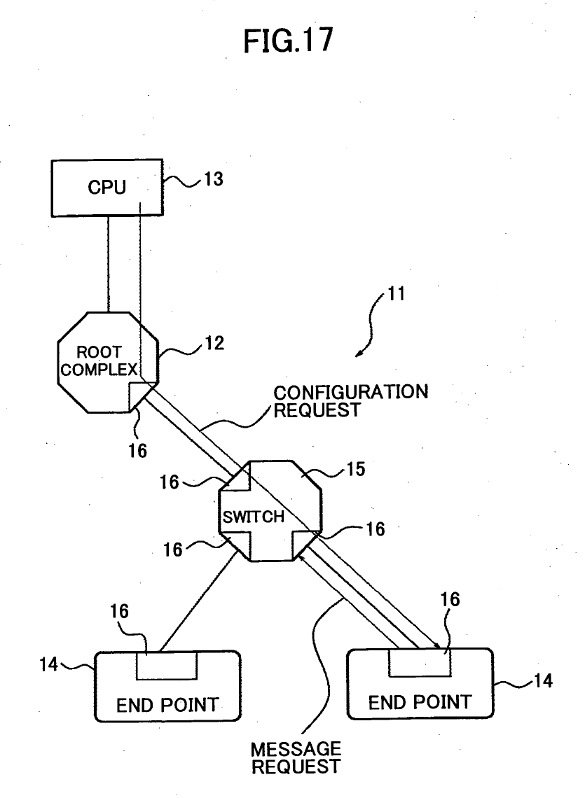

FIG. 17 is a block diagram showing a data transferring system based on the PCI Express standard which is used by the digital copying machine shown in FIG. 16. As shown in FIG. 17, in the digital copying machine 1, internal communications are executed by using a data transferring system 11 of the PCI Express standard.

In other words, a root complex 12 is the controller 4 shown in FIG. 16, a CPU of the root complex 12 is a CPU 13 of the controller 4, the scanner 2 shown in FIG. 16 is an end point 14, and the plotter 3 shown in FIG. 16 is another end point 14. The reference number 15 is a switch.

The data transferring system 11 has a tree structure in its data transferring routes. Routes between nodes in the tree structure, that is, routes between the root complex 12 and the switch 15 and between the switch 15 and the end point 14 are connected “point to point”. In addition, communications between the facing nodes are executed between ports 16 provided in the nodes by matching the settings between them.

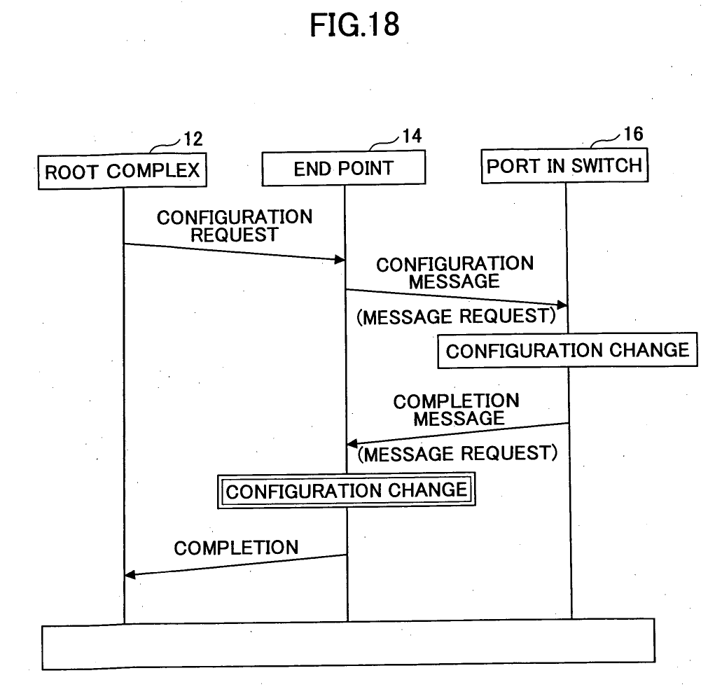

FIG. 18 is a communications sequence chart of the data transferring system 11 shown in FIG. 17. In FIG. 18, a port in switch 16 is a port in the switch 15 that executes communications with the port 16 in the end point 14.

Next, referring to FIGS. 17 and 18, processes being executed by the data transferring system 11 are explained.

When it is necessary to change the settings between the switch 15 and the end point 14 which communicate with each other, first, the CPU 13 of the root complex 12 notifies one of the facing ports 16 in the switch 15 and the end point 14 of a setting change based on predetermined software. In this example, the setting change is communicated to the port 16 of the end point 14. This is a first notifying unit. This notification is executed by using a configuration request.

The end point 14 having received this notification (configuration request) notifies the port 16 of the facing switch 15 of the setting change by using the port 16 of the end point 14. This is a second notifying unit. This notification is executed by using a configuration message (message request). In this, this notification is executed by a packet which is valid in a connection between the facing two ports 16 and is invalid in a connection between the other facing ports 16. The message request is sent by the routing standard of the local link.

The port 16 of the switch 15 having received this notification executes the setting change (configuration change) by contents of the received notification. This is a first setting change unit. Further, the port 16 of the switch 15 sends a completion message signifying that the setting change is executed to the port 16 of the facing end point 14 by a message request (this is also the second notifying unit).

The end point 14 having received this notification executes the setting change (configuration change) having the same contents. This is a second setting change unit. Further, the end point 14 sends a notification (completion) that the setting change is completed to the root complex 12.

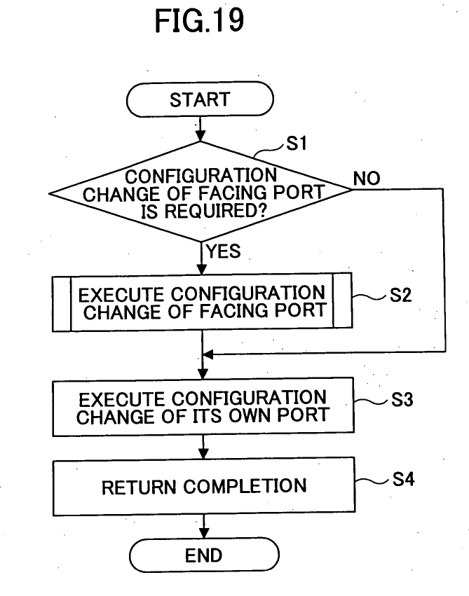

FIG. 19 is a flowchart showing processes that are executed by the data transferring system 11 shown in FIG. 17.

Referring to FIG. 19, the above processes are explained. As shown in FIG. 19, when the end point 14 receives a configuration request from the CPU 13 of the root complex 12 and the configuration request (register) requires the execution of a setting change (configuration change) of the port 16 of the facing switch 15 (YES in step S1), the setting change (configuration change) of the port 16 of the switch 15 is executed (step S2). In addition, the configuration change of the port 16 of the end point 14 is also executed (step S3). Further, the end point 14 returns a notification (completion) that the configuration change is completed to the CPU 13 of the root complex 12 (step S4).

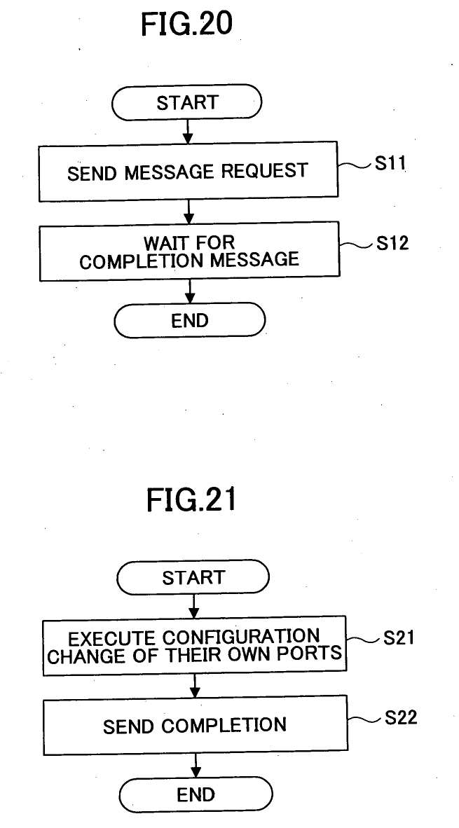

FIG. 20 is a flowchart showing a subroutine which is executed by the end point 14 in step 2 shown in FIG. 19. In step 2 shown in FIG. 19, the end point 14 sends a message request (configuration message) to the port 16 of the facing switch 15 (step S11) and waits for a completion message signifying that the port 16 of the switch 15 has executed the configuration change (step S12).

FIG. 21 is a flowchart showing processes which are executed by the ports 16 of the end point 14 having received the configuration request and the switch 15 having received the configuration message. As shown in FIG. 21, the end point 14 and the switch 15 execute the configuration change of their own ports 16 (step S21), the switch 15 returns the completion message to the end point 14, and the end point 14 returns a completion to the CPU 13 of the root complex 12 (step S22). Since the message request is a posted request, a message for completion is defined and the completion message is worked as a pseudo non-posted request. In this, the posted request does not need a completion packet and the non-posted request needs the completion packet.

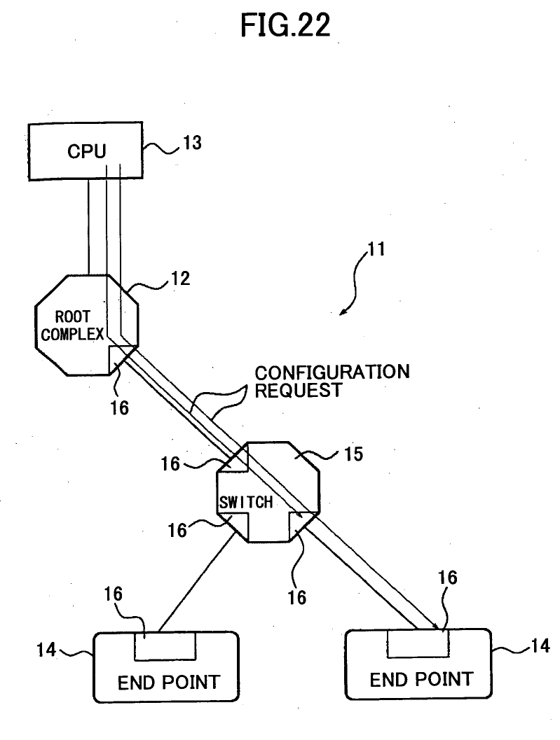

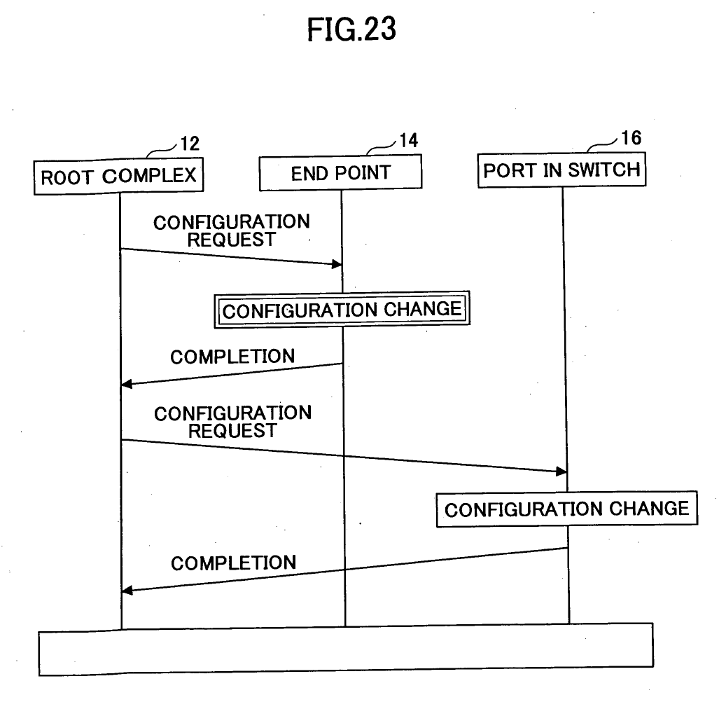

FIG. 22 is a block diagram showing a conventional data transferring system of the PCI Express standard. FIG. 23 is a communication sequence chart of the conventional data transferring system shown in FIG. 22. In FIGS. 22 and 23, the structural elements are the same as those in the embodiment of the present invention shown in FIGS. 17 and 18. However, the processes are different between the embodiment of the present invention and the conventional system.

As shown in FIGS. 22 and 23, conventionally, a configuration request is sent to both the switch 15 and the end point 14 from the CPU 13 of the root complex 12, and the setting changes (configuration changes) of the switch 15 and the end point 14 are executed. In addition, the CPU 13 receives notifications signifying completions of the configuration changes of the switch 15 and the end point 14, respectively, via the root complex 12.

As described above, in the conventional system, the notification of the setting change (configuration change) is sent to both the facing ports 16 of the nodes by using the configuration request. However, a packet (message request), whose format is different from the configuration request, is used for communicating the configuration changes of the facing ports 16 in the embodiment of the present invention.

In the conventional PCI Express standard, the configuration request is transmitted to both the switch 15 and the end point 14 and the completion message (completion) is received from the both of them. Therefore, the work load for the CPU 13 is heavier than that in the embodiment of the present invention shown in FIGS. 17 and 18 because the completion message must be received from the both of them.

In addition, in the conventional system, the CPU 13 must execute complicated processes, such as a process detecting the bus number and the device number of the port 16 of the switch 15 by searching the tree structure in the data transferring system 11 of the PCI Express standard.

On the other hand, according to the data transferring system 11 in the embodiment of the present invention shown in FIGS. 17 and 18, it is enough that the CPU 13 send the configuration request only to the end point 14; in addition, there is no need to execute the complicated processes, such as the process detecting the bus number and the device number of the port 16 of the switch 15. Therefore, according to the embodiment of the present invention, processes to execute matching the settings between the facing ports 16 can be made simple, the software is simplified, and the amount of data to be processed in the software can be reduced.

Further, in order that the CPU 13 can decide whether the switch 15 and the endpoint 14 are devices in the embodiment of the present invention shown in FIGS. 17 and 18 or conventional devices shown in FIGS. 22 and 23, functions of a third notifying unit and a fourth notifying unit that notify the CPU 13 which instructs the first notifying unit whether the devices are ones of the present invention or the conventional ones from the ports 16 of the switch 15 and the end point 14 can be provided.

Further, the present invention is not limited to the specifically disclosed embodiment, and variations and modifications may be made without departing from the scope of the present invention.

The present invention is based on Japanese Priority Patent Application No. 2005-008866, filed on Jan. 17, 2005, with the Japanese Patent Office, the entire contents of which are hereby incorporated by reference.

What is claimed is:

1. A data transferring system, in which a data transferring route has a tree structure and a connection between nodes on the tree structure is point to point and communications between facing nodes are executed by matching settings between facing ports of the facing nodes, comprising:
a first notifying unit that notifies one of the facing ports of a setting change when settings between the facing ports are to be changed;
a second notifying unit that is a port having received the notification of the setting change and notifies the other port of the setting change;
a first setting change unit that is the other port having received the notification of the setting change and executes the setting change; and
a second setting change unit that is the port having received the execution of the setting change from the other port and executes the setting change.

2. The data transferring system as claimed in claim 1, wherein:
the second notifying unit executes the notification of the setting change by using a packet whose format is different from a packet that is used in a case where the setting change between the facing ports is executed by notifying both the facing ports of the setting change.

3. The data transferring system as claimed in claim 1, wherein:
the second notifying unit executes the notification of the setting change by using a packet which is valid in a connection between the facing two ports and is invalid in a connection between other facing ports.

4. The data transferring system as claimed in claim 1, wherein:
the data transferring system is based on the PCI Express standard.

5. The data transferring system as claimed in claim 4, wherein:
the facing nodes are a switch and an end point.

6. The data transferring system as claimed in claim 4, wherein:
the first notifying unit is a CPU of a root complex.

7. The data transferring system as claimed in claim 4, wherein:
the first notifying unit executes the notification of the setting change by a configuration request and the second notifying unit executes the notification of the setting change a message request.

8. The data transferring system as claimed in claim 7, wherein:
the second notifying unit sends the message request by the routing standard of a local link.

9. The data transferring system as claimed in claim 6, wherein:
the port having the second notifying unit and the second setting change unit provides a third notifying unit that notifies the CPU of the root complex of that the second notifying unit executes the notification of the setting change by the message request; and
the port having the second notifying unit and the first setting change unit provides a fourth notifying unit that notifies the CPU of the root complex of that the second notifying unit executes the notification of the setting change by the message request.

10. An electronic apparatus providing a data transferring system as claimed in claim 1.
